(19) United States
(12) Patent Application Publication
(10) Pub. No.: US 2021/0264784 A1
(43) Pub. Date: Aug. 26, 2021

(54) SERVER, VEHICLE OPERATION SYSTEM, VEHICLE OPERATION METHOD AND NON-TRANSITORY COMPUTER READABLE MEDIUM

(71) Applicant: TOYOTA JIDOSHA KABUSHIKI KAISHA, Toyota-shi (JP)

(72) Inventors: Yuki TATSUMOTO, Nagoya-shi (JP); Saori MATSUMOTO, Chofu-shi (JP); Keigo YAMADA, Toyota-shi (JP); Akira SASAKI, Miyoshi-shi (JP); Mitsuhiro MIURA, Toyota-shi (JP)

(73) Assignee: TOYOTA JIDOSHA KABUSHIKI KAISHA, Toyota-shi (JP)

(21) Appl. No.: 17/181,130

(22) Filed: Feb. 22, 2021

(30) Foreign Application Priority Data
Feb. 20, 2020 (JP) 2020-027550

(51) Int. Cl. G08G 1/127; G05B 19/418; G01C 21/34; G01C 21/36

(52) U.S. Cl. CPC G08G 1/127; G05B 19/41895; G05B 2219/50393; G01C 21/3407; G01C 21/3626; G05B 19/41865

(57) ABSTRACT

A server includes a communication interface and a controller. The communication interface is configured to receive request information including first location information and purpose information, the first location information indicating a location of a user, and the purpose information indicating a travel purpose of the user. The controller is configured to search operation schedule information indicating respective operation routes of a plurality of vehicles and times at which each vehicle is scheduled to pass through a plurality of places on a corresponding operation route, and facility information including second location information and attribute information, the second location information indicating respective locations of a plurality of facilities, and the attribute information indicating respective attributes of the plurality of facilities. When the communication interface has received the request information, the controller extracts a first facility and a boarding vehicle based on the operation schedule information, the facility information, and the request information.

### CROSS-REFERENCE TO RELATED APPLICATION

This application claims the priority to Japanese Patent Application No. 2020-027550, filed on Feb. 20, 2020, the entire contents of which are incorporated herein by reference.

### TECHNICAL FIELD

The present disclosure relates to a server, a vehicle operation system, a vehicle operation method, and a non-transitory computer readable medium.

### BACKGROUND

Vehicles that operate on demand from users are known. For example, Patent Literature (PTL) 1 discloses a method of dispatching an on-demand bus for improving operation efficiency.

### CITATION LIST

### Patent Literature

PTL 1: JP 2019-016290 A

### SUMMARY

When managing the operations of a plurality of vehicles that a plurality of users can board as passengers, an entity managing the operations needs to transport the users in a flexible and efficient manner from points of origin to destinations according to purposes of the users.

It would be helpful to improve flexibility in travel for users who use an on-demand vehicle dispatch service.

A server according to an embodiment of the present disclosure includes:

a communication interface configured to receive, from an information terminal, request information including first location information and purpose information, the first location information indicating a location of a user, and the purpose information indicating a travel purpose of the user; and

a controller configured to search operation schedule information indicating respective operation routes of a plurality of vehicles and times at which each vehicle is scheduled to pass through a plurality of places on a corresponding operation route, and facility information including second location information and attribute information, the second location information indicating respective locations of a plurality of facilities, and the attribute information indicating respective attributes of the plurality of facilities, the controller being configured to, when the communication interface has received the request information, extract a first facility in the plurality of facilities that has an attribute matching the purpose information, a boarding vehicle in the plurality of vehicles that can be used by the user to travel to the first facility, and a boarding location on an operation route of the boarding vehicle at which the user is to board and an alighting location on the operation route of the boarding vehicle at which the user is to alight, based on the operation schedule information, the facility information, and the request information.

A vehicle operation system according to an embodiment of the present disclosure includes:

the server; and

a plurality of vehicles each configured to be operated in accordance with the operation schedule information.

A vehicle operation method according to an embodiment of the present disclosure includes:

receiving, from an information terminal, request information including first location information and purpose information, the first location information indicating a location of a user, and the purpose information indicating a travel purpose of the user; and

extracting, based on the request information, operation schedule information indicating respective operation routes of a plurality of vehicles and times at which each vehicle is scheduled to pass through a plurality of places on a corresponding operation route, and facility information including second location information indicating respective locations of a plurality of facilities and attribute information indicating respective attributes of the plurality of facilities, a first facility in the plurality of facilities that has an attribute matching the purpose information, a boarding vehicle in the plurality of vehicles that can be used by the user to travel to the first facility, and a boarding location on an operation route of the boarding vehicle at which the user is to board and an alighting location on the operation route of the boarding vehicle at which the user is to alight.

A vehicle operation program according to an embodiment of the present disclosure is configured to cause a processor to execute operations including:

acquiring request information including first location information and purpose information, the first location information indicating a location of a user, and the purpose information indicating a travel purpose of the user; and

extracting, based on the request information, operation schedule information indicating respective operation routes of a plurality of vehicles and times at which each vehicle is scheduled to pass through a plurality of places on a corresponding operation route, and facility information including second location information indicating respective locations of a plurality of facilities and attribute information indicating respective attributes of the plurality of facilities, a first facility in the plurality of facilities that has an attribute matching the purpose information, a boarding vehicle in the plurality of vehicles that can be used by the user to travel to the first facility, and a boarding location on an operation route of the boarding vehicle at which the user is to board and an alighting location on the operation route of the boarding vehicle at which the user is to alight.

A server, a vehicle operation system, a vehicle operation method, and a vehicle operation program according to an embodiment of the present disclosure may improve flexibility in travel for the users who use the on-demand vehicle dispatch service.

### BRIEF DESCRIPTION OF THE DRAWINGS

In the accompanying drawings:

FIG. 1 is a schematic diagram illustrating a configuration example of a vehicle operation system according to an embodiment;

FIG. 2 is a block diagram illustrating a configuration example of the vehicle operation system according to the embodiment;

FIG. 3 illustrates information managed by a server according to the embodiment;

FIG. 4 illustrates an example of a hierarchical structure of attribute information according to the embodiment;

FIG. 5 illustrates an example of information managed by a vehicle according to the embodiment;

FIG. 6 is a side view illustrating a configuration example of the vehicle according to the embodiment;

FIG. 7 illustrates communications between an information terminal, the server, and the vehicle in the embodiment;

FIG. 8 is a flowchart illustrating an example of a procedure executed by the server;

FIG. 9 provides a supplemental explanation about a method of extracting a first facility according to the embodiment;

FIG. 10 is a flowchart illustrating an example of a procedure for extracting the first facility in the flowchart of FIG. 8;

FIG. 11 is a flowchart illustrating another example of the procedure for extracting the first facility in the flowchart of FIG. 8; and

FIG. 12 is a flowchart illustrating an example of a procedure executed by a control apparatus of the vehicle.

### DETAILED DESCRIPTION

An embodiment of the present disclosure will be described below with reference to the drawings. The drawings used in the following description are schematic. Dimensional ratios or the like on the drawings do not necessarily match actual ones

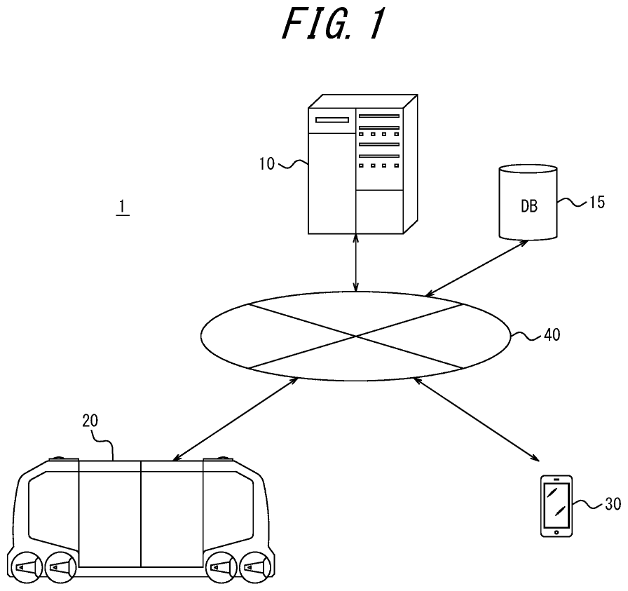

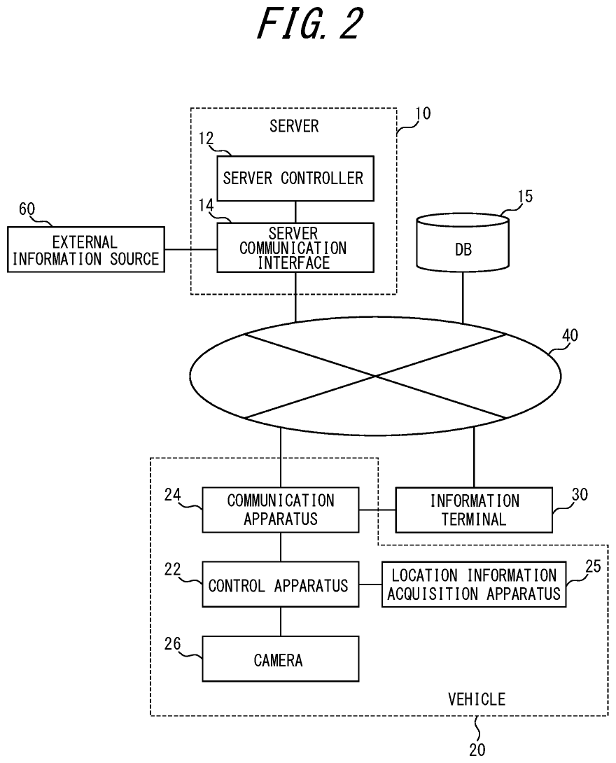

As illustrated in FIG. 1 and FIG. 2, a vehicle operation system 1 according to the embodiment includes a server 10, a vehicle 20, and an information terminal 30. The server 10, the vehicle 20, and the information terminal 30 are connected to a network 40 and can communicate with each other. A database (DB) 15 is also connected to the network 40, but this is not required. Each of the server 10, the vehicle 20, the information terminal 30, and the DB 15 is not limited to one and may be two or more in number. The vehicle operation system 1 may include the DB 15. The DB 15 may include an external database that is not included in the vehicle operation system 1.

The vehicle operation system 1, based on a request made by a user at the information terminal 30, presents a facility to the user that matches the content of the request, and a boarding location and a boarding time and an alighting location and an alighting time for the vehicle 20 which will be the mode of transportation. When the user accepts the presented content, the user can make a reservation to board the vehicle 20 pertaining to the mode of transportation. Herein, a person who uses the vehicle operation system 1 is referred to as the “user”, and a person who boards the vehicle 20 is referred to as a “passenger”. The “user” is encompassed in the “passenger” when the “user” boards the vehicle 20 by using the vehicle operation system 1.

The vehicle 20 presented by the vehicle operation system 1 is a vehicle that has been dispatched in advance based on reservations from one or more other passengers. It is assumed that the user shares a ride in the vehicle 20 that has been dispatched in advance based on the reservations from the other passengers. An operation schedule for the vehicle 20 is defined prior to the request from the user, based on the reservations from the one or more passengers. This, however, does not prevent the server 10 of the vehicle operation system 1 from coordinating the predefined schedule so as to let the user board the vehicle 20. The operation schedule includes, for the individual vehicle 20, an operation route and times at which the vehicle 20 is scheduled to pass through a plurality of places on the operation route. The service for operating the vehicle 20 and letting the passengers board the vehicle 20 based on the reservations from the passengers is also referred to as an on-demand bus service. The following description takes a bus as an example of the vehicle 20 used in the on-demand bus service. The vehicle 20 is, however, not limited to the bus. The vehicle 20 includes a passenger vehicle that a plurality of people can board.

The allocation of the vehicle 20 and the definition of the operation schedule based on the reservations from the passengers may be performed by the server 10 or may be performed by a system other than the vehicle operation system 1. Operation schedule information, that is, information about the operation schedule for each vehicle 20, may be stored in the DB 15 for management or may be stored in a later-described memory in the server 10. The operation schedule information may include, for each vehicle 20, the number of people who are scheduled to board along the operation route, the number of people who can additionally board, and the like, in addition to the information about the operation route and the times at which the vehicle 20 is scheduled to pass through the plurality of places on the operation route. The server 10 can search the operation schedule information. The server 10 can coordinate the operational schedule information. For example, the server 10 can set a stopping location on or around the operation route for boarding or alighting of the user, and stopping times. The server 10 may receive, from each individual vehicle 20, the operation schedule information reflecting an actual operation status on the operation route and may update the operation schedule information in the memory. The operation schedule information is server management information managed by the server 10.

(Server)

The server 10 may include a single server apparatus, or a plurality of server apparatuses capable of communicating with each other. The server 10 may be operated, for example, by an entity that provides the on-demand bus service. The server 10 can transmit and receive various types of information to and from the vehicle 20 and the information terminal 30. The server 10 is configured to execute various types of processing related to the service provided by the vehicle operation system 1. The server 10 may manage the operation of the vehicle 20. The server 10 may communicate with the vehicle 20 to thereby acquire various types of information regarding the vehicle 20, such as a location or a speed of the vehicle 20. The server 10 may acquire congestion information regarding a congestion condition on the operation route, from the vehicle 20 or an information source outside the vehicle operation system 1. The server 10 may be configured to execute, in addition to the above processing, various types of processing to manage the operation of the vehicle 20.

The server 10 includes a server controller 12 and a server communication interface 14. The server controller 12 is also referred to simply as a controller. The server controller 12 may include one or more processors. The “processors” in the present embodiment may be, but are not limited to, general-purpose processors, dedicated processors that are dedicated to specific processing, or the like. The server controller 12 may include one or more dedicated circuits. Examples of dedicated circuits may include a Field-Programmable Gate Array (FPGA) and an Application Specific Integrated Circuit (ASIC). The server controller 12 may include the dedicated circuits instead of the processors, or may include the dedicated circuits along with the processors. The server communication interface 14 is also referred to simply as a communication interface. The server communication interface 14 includes a communication module and may communicate with each vehicle 20.

The server 10 may further include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disc. The memory may store any information used for the operation of the server 10. For example, the memory may store a system program, an application program, or the like. The server 10 may store a program, information, or the like, using the DB 15 as the memory. The memory may be included in the server controller 12.

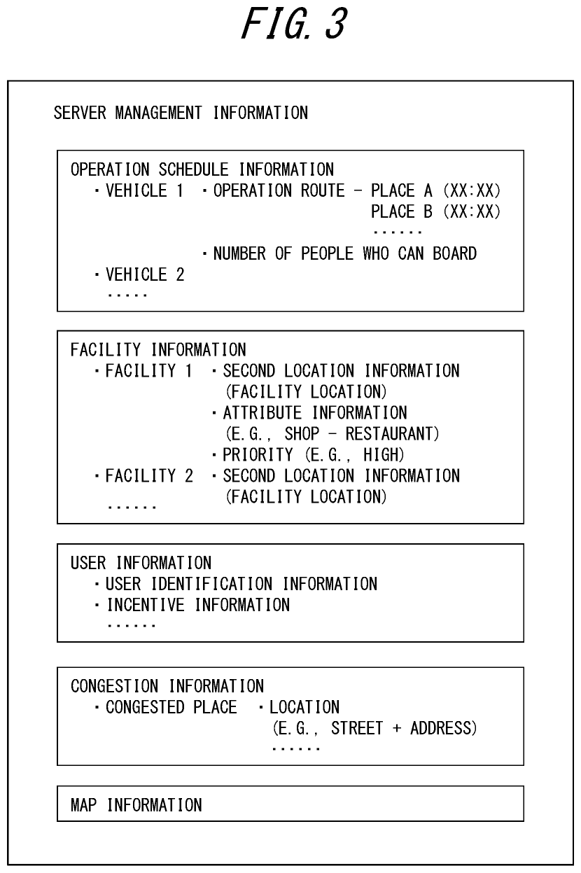

FIG. 3 illustrates the server management information that is stored in the DB 15 or the memory of the server 10 and that can be managed by the server 10. The server management information includes the operation schedule information and facility information regarding a plurality of facilities. The server 10 can search the operation schedule information regarding the plurality of vehicles 20 and the facility information regarding the plurality of facilities, in accordance with predetermined conditions. When the operation schedule information and the facility information is stored in the DB 15, the server 10 may search the operation schedule information and the facility information stored in the DB 15, in accordance with the predetermined conditions.

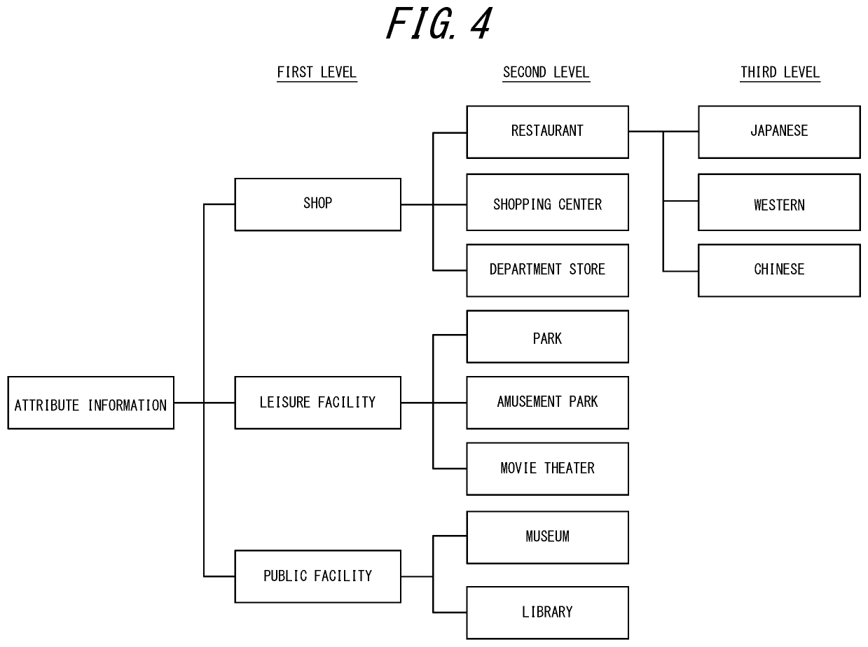

The facility information includes second location information indicating respective locations of the plurality of facilities, and attribute information indicating respective attributes of the plurality of facilities. The location information may be specified by a latitude and a longitude, a location on a predetermined map, or the like. The attribute information indicates a feature of each facility itself or a service provided by the facility. As illustrated in FIG. 4, the attribute information may have a hierarchical structure that has two or more levels. For example, a first level in the attribute information includes any one of a shop, a leisure facility, a public facility, etc. When the first level in the attribute information is a shop, a second level in the attribute information may include any one of a restaurant, a shopping center, a department store, etc. The plurality of facilities can be classified by the attribute information.

The facility information may further include priority information. The priority information indicates, for each facility, a priority of the facility. The priority information can be used by the server controller 12 in extracting a facility to be presented to the user. Any facility with a high priority is preferentially presented to the user. For instance, the priority of any facility having partnership or business relationship with the entity operating the vehicle operation systems 1 can be set high. For another instance, the priority of any facility providing an alighting location to the entity operating the vehicle operation system 1 can be set high.

The server management information may further include user information, the congestion information, and map information. The user information includes user identification information identifying the user. The user identification information can also be called a user ID. The user identification information may be stored in association with a user name, a contact, billing information, and the like. When the vehicle operation system 1 provides an incentive to the user depending on a past record of usage of the user, the user information may include incentive information regarding the incentive associated with the user identification information.

The congestion information indicates traffic congestion conditions on the respective operation routes of the plurality of vehicles 20. The server 10 may collect the congestion information by any means. The server controller 12 may be configured to receive the congestion information from the plurality of vehicles 20 via the server communication interface 14. For example, each vehicle 20 may determine a traffic jam and transmit the congestion information to the server 10 based on time actually taken to pass respective sections of the operation route. Alternatively, each vehicle 20 may acquire a surrounding image during operation to determine congestion and transmit the congestion information to the server 10. The server controller 12 may acquire the congestion information from an external information source 60, such as a traffic information service provider that is not included in the vehicle operation system 1. The server 10 may update the operation schedule information based on the current congestion information. The server controller 12 may store the congestion condition on each operation route in the past and may retain, in the memory, information indicating, for each day and for each time of day, a location with high congestion probability, as the congestion information.

The map information indicates geographical information of an area in which the vehicle operation system 1 provides the service. The map information includes information about roads. The operation schedule information for the vehicles 20 and the second location information for the facilities may be stored in association with the map information. The map information may also include information about a location in which parking of the vehicles 20 is easily accomplished, a location in which the parking is prohibited, and the like.

(Vehicle)

The vehicle 20 is, for example, a passenger transportation vehicle, such as a bus used in the on-demand bus service, but is not limited thereto and may be any vehicle that the user can use as a passenger. The vehicle 20 is not limited to one and may be two or more in number. The vehicle 20 may be a vehicle that can operate by autonomous driving. The autonomous driving of the vehicle 20 may be performed, for example, at any level from Level 1 to Level 5 as defined by the Society of Automotive Engineers (SAE). The automated driving is not limited to the exemplified definition and may be performed based on other definitions.

As illustrated in FIG. 2, the vehicle 20 is equipped with a control apparatus 22 and a communication apparatus 24. The control apparatus 22 and the communication apparatus 24 are communicably connected to each other via, for example, an in-vehicle network such as a Controller Area Network (CAN), or a dedicated line.

The control apparatus 22 controls individual components included in the vehicle 20. The control apparatus 22 may include one or more processors. The control apparatus 22 may include one or more dedicated circuits instead of the processors, or may include one or more dedicated circuits along with the processors. The control apparatus 22 may further include a memory.

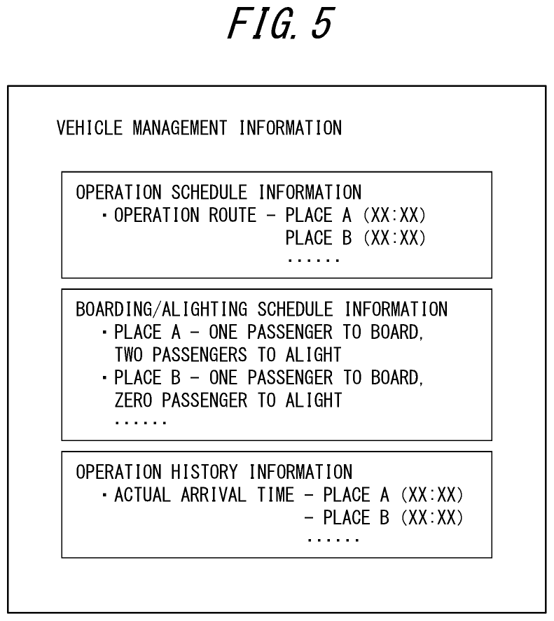

The vehicle 20 may store vehicle management information in the memory of the control apparatus 22. The vehicle 20 may include a different memory apparatus than the memory of the control apparatus 22, and may store the vehicle management information in the memory apparatus. As illustrated in FIG. 5, the vehicle management information includes the vehicle 20's own operation schedule information and boarding/alighting schedule information. The vehicle 20's own operation schedule information includes the vehicle 20's own operation route and the times at which the vehicle 20 is scheduled to pass the plurality of places on the operation route. The vehicle 20 is to operate on the operation route in accordance with the operation schedule information. The boarding/alighting schedule information includes information about the number of people who are scheduled to board or alight at the plurality of places on the operation route. In accordance with the boarding/alighting schedule information, the vehicle 20 allows the passengers to board or alight at a plurality of stopping locations on the operation route. The vehicle management information may further include operation history information. The operation history information may include information about an actual arrival time at each place on the operation route of the vehicle 20. The control apparatus 22 may update the operation schedule information in real time based on the actual arrival time. When updating the operation schedule information for the vehicle 20, the control apparatus 22 may transmit the updated information to the server 10 via the communication apparatus 24.

The communication apparatus 24 communicates with the server 10 via the network 40. The communication apparatus 24 may communicate with the information terminal 30 via the network 40, or may communicate with the information terminal 30 without using the network 40. The communication apparatus 24 may be, for example, an in-vehicle communication device. The communication apparatus 24 may include a communication module to connect with the network 40. The communication module may include, but is not limited to, a communication module conforming to mobile communication standards, such as the 4^{th} Generation (4G) standard or the 5^{th} Generation (5G) standard. The communication apparatus 24 may be configured to communicate with the information terminal 30 through Near Field Communication (NFC), Bluetooth® (Bluetooth is a registered trademark in Japan, other countries, or both), or the like.

The communication apparatus 24 can transmit and receive various types of information to and from the server communication interface 14 of the server 10. For example, the communication apparatus 24 can transmit the congestion information and the updated operation schedule information to the server communication interface 14. The server communication interface 14 can also transmit, to the communication apparatus 24, boarding information that enables the user to board. The boarding information includes boarding permission information that the control apparatus 22 of the vehicle 20 can use to verify the user who has made the boarding reservation, and information about the boarding location and the alighting location of the user.

As illustrated in FIG. 2, the vehicle 20 may further include a location information acquisition apparatus 25. The location information acquisition apparatus 25 and other components mounted in the vehicle 20 are connected so as to communicate with each other, via the in-vehicle network such as the CAN, or the dedicated line. The location information acquisition apparatus 25 acquires location information for the vehicle 20. The location information acquisition apparatus 25 may include a receiver compatible with a satellite positioning system. The receiver compatible with the satellite positioning system may include, for example, a Global Positioning System (GPS) receiver. In the present embodiment, the vehicle 20 is assumed to be capable of acquiring the location information for the vehicle 20 itself by using the location information acquisition apparatus 25.

The vehicle 20 may further include a camera 26. The camera 26 captures an image of a road condition around the vehicle 20. The camera 26 may include an imaging device to capture an image of visible light, or an imaging device to capture an image of electromagnetic waves other than visible light, such as infrared light. The image captured by the camera 26 is also referred to as an in-vehicle camera image. The vehicle 20 may determine the congestion condition from the camera image and transmit a result of the determination as the congestion information to the server 10 by using the communication apparatus 24. The vehicle 20 may transmit the in-vehicle camera image as the congestion information to the server 10 by using the communication apparatus 24. In this case, the congestion condition is determined by the server 10.

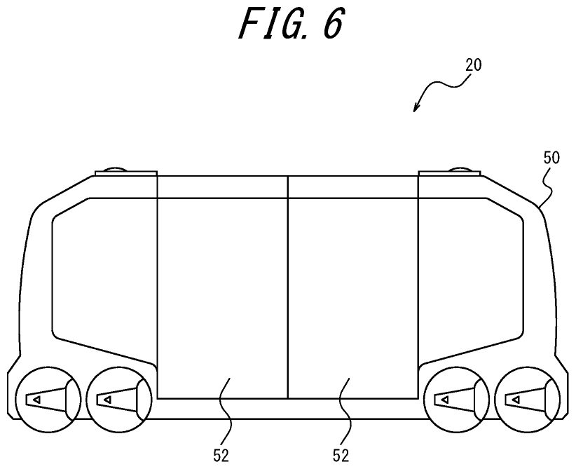

As illustrated in FIG. 6, the vehicle 20 includes a body 50. The vehicle 20 may further include a door 52. The door 52 is openable and closable. The door 52 may be opened and closed in a variety of manners, such as a sliding manner or a folding manner. The user may board and alight the vehicle 20 with the door 52 open. The vehicle 20 may travel with the door 52 closed. By communicating with the information terminal 30 of the user, the vehicle 20 may authenticate whether the user is the user who has made the reservation. For example, the vehicle 20 may open the door 52 when the user who has made the reservation approaches the vehicle 20 while stationary.

(Information Terminal)

The information terminal 30 is an information terminal including an input/output interface, an information processor, a communication interface, and a location detector. As the information terminal 30, for example, a mobile information terminal, such as a smart phone, may be used. The input/output interface includes, for example, a liquid crystal display with a touch panel. The information terminal 30 can receive an input from the user through the input/output interface and display, to the user, information processed by the information terminal 30. The information processor is configured with a processor. The information processor executes various types of information processing in the information terminal 30. The communication interface is configured with, for example, a wireless communication module conforming to a communication method for the network 40. With the communication interface, the information terminal 30 can communicate with the server 10 via the network 40. The information terminal 30 may communicate with the vehicle 20 via the network 40. The location detector may include a configuration that, for example, is identical or similar to that of the location information acquisition apparatus 25 included in the vehicle 20. The location detector can detect the location of the information terminal 30 itself.

The information terminal 30 may run an application that is used to use the service provided by the vehicle operation system 1. In accordance with the application, the information terminal 30 can handle input of information from the user, output of information to the user, and transmission and receipt of information to and from the server 10.

The information terminal 30 may include means to communicate with the vehicle 20 without using the network 40. When the user boards the vehicle 20, the information terminal 30 may communicate directly with the vehicle 20 and may transmit and receive the boarding permission information for authenticating whether the vehicle 20 is the vehicle 20 allocated to the user's boarding reservation.

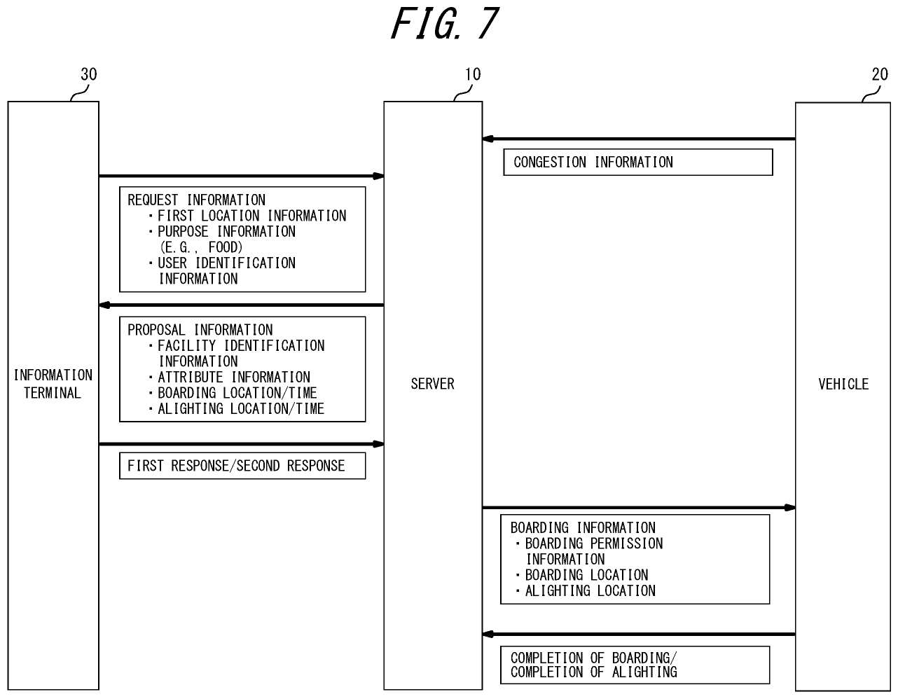

In accordance with the above explanation, FIG. 7 illustrates an example of information transmitted and received between the information terminal 30 and the server 10, and between the server 10 and the vehicle 20. The vehicle 20 transmits the congestion information to the server 10 as appropriate. The information terminal 30 transmits the request information to the server 10 in response to an operation made by the user. Upon receiving the request information, the server 10 transmits proposal information to the information terminal 30. In response to an operation made by the user, the information terminal 30 transmits to the server 10 a first response or a second response to the proposal information. When the proposal information is accepted by the user, the server 10 transmits the boarding information to the vehicle 20 which is the boarding vehicle. The vehicle 20 which is the boarding vehicle transmits to the server 10 information indicating completion of boarding or completion of alighting when the user has boarded or alighted from the vehicle 20.

(Vehicle Operation Method)

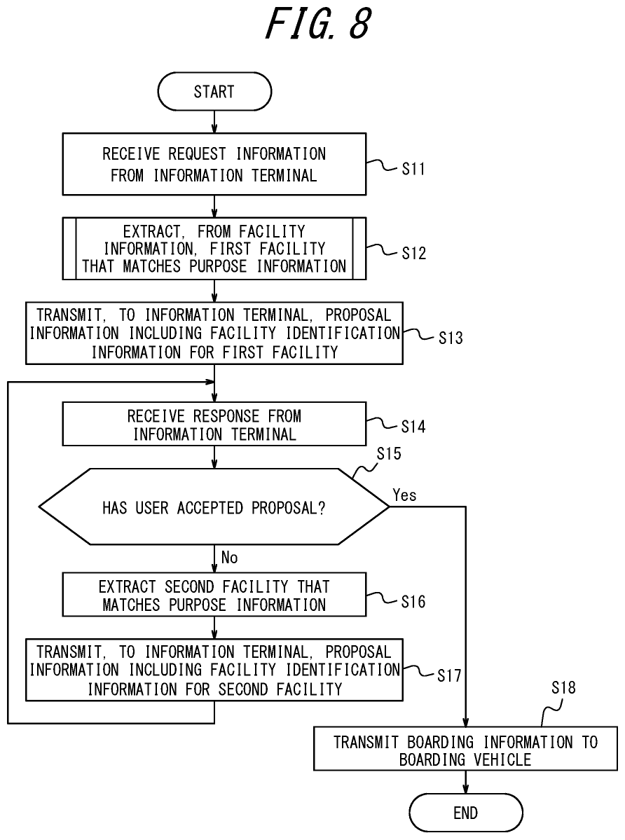

The server 10 may perform a vehicle operation method according to the present disclosure in accordance with a procedure of the flowchart illustrated in FIG. 8. The vehicle operation method may be implemented as a vehicle operation program executed by the server controller 12. The vehicle operation program may be stored in a non-transitory computer readable medium. Examples of non-transitory computer readable media may include, but are not limited to, a hard disk, a RAM, a ROM, a flash memory, a CD-ROM, an optical storage device, and a magnetic storage device.

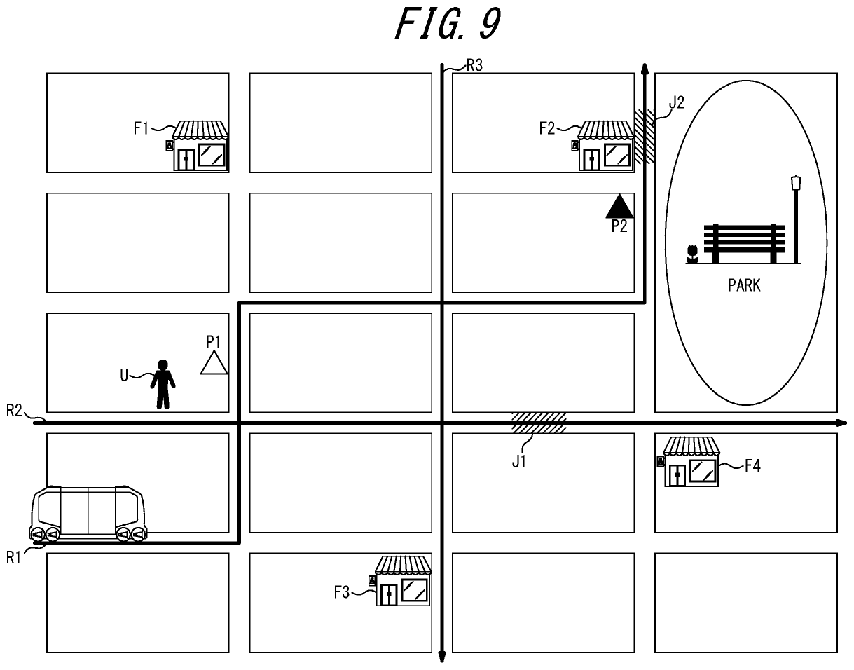

Hereinafter, a more specific example of the procedure of processing executed by the server 10 will be described with reference to FIG. 9, along with a description of the flowchart in FIG. 8. FIG. 9 merely illustrates one example of a usage scenario in which the vehicle operation system 1 is used, and does not impose any limitations on the server, the vehicle operation system, the vehicle operation method, and the vehicle operation program according to the present disclosure.

First, the server controller 12 receives, through the server communication interface 14, the request information from the information terminal 30 of the user (Step S11). The user can transmit the request information to the server 10 by operating the information terminal 30 in possession of the user. The request information includes first location information indicating the location of the user and purpose information indicating a travel purpose of the user.

As an example of the usage scenario in which the vehicle operation system 1 is used, it is assumed that the user wants to travel as soon as possible in accordance with the current travel purpose. Under this circumstance, the first location information may be the current location of the user detected by the location detector included in the information terminal 30. In other circumstances, the user wants to travel after a predetermined time has elapsed from a current time. Under these circumstances, the user may input, through the information terminal 30, the expected location of the user at the predetermined time. In the latter circumstances, the request information may further include information about a desired boarding time at which the user desires to board the vehicle 20.

The purpose information includes, for example, “dining”, “shopping”, “leisure”, “art appreciation”, or the like. The user can launch an application on the information terminal 30 and select the travel purpose from the plurality of options.

By sending the request information to the server 10, the user can request the server 10 to make a proposal for the destination facility and the mode of transportation.

The request information may further include user identification information for the server 10 to identify the user. When, for example, the service of the vehicle operation system 1 is provided as a membership service, the user identification information may include a membership number of the user. The user identification information may be stored in advance in the information terminal 30. The user identification information does not necessarily need to be included in the request information in Step S11 and may be transmitted from the information terminal 30 to the server 10 in a subsequent step.

For example, in the example illustrated in FIG. 9, user U having an outing launches the application on the information terminal 30 and inputs the travel purpose. As the travel purpose, “dining” for example may be selected. This means that user U wants to go to a place to dine. User U may enter a desired boarding location and the desired boarding time, in addition to the travel purpose. In the example of FIG. 9, it is assumed that user U wants to travel from the current location as soon as possible. Under this circumstance, the input of the desired boarding location and the time to start travelling may be omitted. As the desired boarding location, the current location detected by the location detector in the information terminal 30 is automatically acquired.

By, for example, user U pressing an icon to a submit button that is displayed on the touch panel of the information terminal 30, the request information including the first location information indicating the location information, i.e., the user's desired boarding location, and the purpose information indicating the travel purpose is transmitted to the server 10.

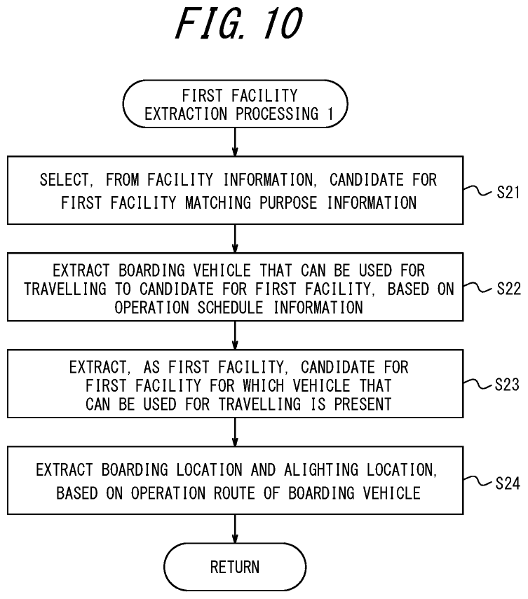

The server controller 12 extracts, from the facility information, a facility having an attribute matching the purpose information included in the request information, as the first facility (Step S12). The extraction of the first facility may be performed, for example, in accordance with the flowchart of FIG. 10.

Firstly, the server controller 12 selects, from the plurality of facilities included in the facility information, the facility having an attribute matching the purpose information included in the request information as a candidate for the first facility (Step S21). The candidate for the first facility may be plural in number. The purpose information, which is selectable through the application on the information terminal 30, may be associated one-to-one or one-to-N with the attribute information included in the facility information in advance in the form of a table representing a correspondence relationship.

Suppose, for example, that the purpose information included in the request information is “dining” in the example illustrated in FIG. 9. When the levels of the attribute information as illustrated in FIG. 4 are included in the server management information, the server controller 12 can extract any facility having an attribute whose first level is a store and second level is a restaurant. For the facility where “dining” is possible, the server controller 12 selects, for example, facilities F1 to F4 as the candidates for the first facility from the facilities stored in the facility information.

Subsequent to Step S21, the server controller 12 searches the operation schedule information, and extracts a vehicle 20 that can be used for travelling to the candidates for the first facility as the boarding vehicle (Step S22). The vehicle 20 that can be used for travelling to the candidates for the first facility is a vehicle 20 that is scheduled to pass close by the location indicated by the first location information at a time close to the user's desired boarding time and to pass a location close by the location indicated by the second location information of any one of the candidates for the first facility. The server controller 12 may apply a distance-based criterion to determine whether the location is close. For example, the server controller 12 may determine the location to be close if it is within 50 m. Such a criterion may be set by the user by using the informational terminal 30.

The server controller 12 extracts a candidate for the first facility for which the boarding vehicle that can be used for travelling has been extracted as the first facility (Step S23). The first facility extracted by the server controller 12 may be one or more in number. In extracting the first facility, the server controller 12 may consider the priority information included in the facility information. For example, the server controller 12 may extract the facility with the highest priority even a plurality of such first facilities can be extracted. In extracting the first facility, the server controller 12 may extract a single facility by considering the congestion information on the operation route of the boarding vehicle.

For example, in the example illustrated in FIG. 9, user U wants to travel from the current location as soon as possible. Accordingly, the server controller 12 extracts, from operation routes R1 to R3 of the vehicles 20 operated at a time close to the current time, operation routes R1 and R2 each passing close by the current location of user U and close by either one of facilities F2 and F4, and also extracts the vehicles 20 operated on the extracted operation routes.

The server controller 12 may extract both or one of facilities F2 and F4 as the first facility, by considering the priority information or other conditions. The other conditions may include, for example, the arrival time of each vehicle 20 at the location close by the facility. For example, in a case in which traffic jam J1 occurs in part of operation route R2, the server controller 12 may remove facility F4, which is located near operation route R2, and extract only facility F2. In this case, the vehicle 20 which is to travel along operation route R1 leading from the current location of user U closer to facility F2 is regarded as the boarding vehicle.

Subsequent to Step S23, the server controller 12 extracts the boarding location at which the user is to board and the alighting location at which the user is to alight, based on the operation route of the vehicle 20 which is the boarding vehicle (Step S24). The boarding location may be selected from locations on the operation route of the boarding vehicle that are close to the user's desired boarding location, based on the first location information. The alighting location may be selected from locations on the operation route of the boarding vehicle that are close to the location of the first facility, based on the second location information. The server controller 12 can refer to the map information to extract the boarding location and the alighting location. Based on the map information, the server controller 12 can extract, as the alighting location, a location in which parking of the vehicle 20 is easily accomplished while avoiding locations at which the parking is prohibited.

The server controller 12 may determine the boarding location and the alighting location based on the congestion information. The server controller 12 may determine the boarding location and the alighting location so as to avoid congested sections on the operation route. The server controller 12 may adjust the operation route to let the user board and alight without bringing a substantial change in the entire operation schedule.

For example, in the example shown in FIG. 9, from operation route R1 leading to facility F2 that has been extracted as the first facility, the server controller 12 may extract location P1 which is close to the current location of the user as the boarding location, based on the first location information. The server controller 12 may determine alighting location P2 based on the second location information for facility F2 that is included in the facility information. When traffic jam J2 occurs near facility F2, the server controller 12 may determine alighting location P2 so as to avoid the location with traffic jam J2.

Subsequent to Step S24, the processing by the server controller 12 returns to the flowchart of FIG. 8.

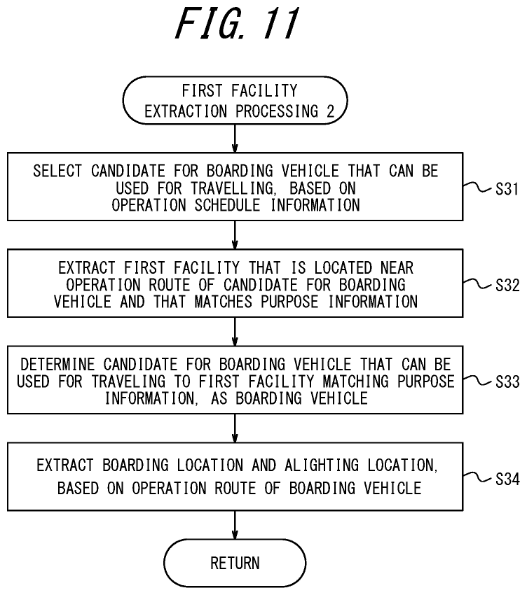

The server controller 12 may also execute the first facility extraction processing in Step S12 in accordance with the flowchart of FIG. 11 which is different from the flowchart of FIG. 10. The first facility extraction processing will be described below with reference to the flowchart of FIG. 11. In the description below relating to the flowchart of FIG. 11, content common to the flowchart of FIG. 10 will be omitted.

Firstly, the server controller 12 selects, from the plurality of vehicles 20, a vehicle 20 that can be used by the user to travel as a candidate for the boarding vehicle, based on the operation schedule information (Step S31). The candidate for the boarding vehicle may be plural in number. Any vehicle 20 that is scheduled to pass along the operation route passing close by the location indicated by the first location information at a time close to the user's desired boarding time is selected as a candidate for the boarding vehicle.

For example, in the example illustrated in FIG. 9, the server controller 12 searches the operation schedule information and extracts, from operation routes R1 to R3 of the vehicles 20 operated at a time close to the current time, operation routes R1 and R2 and the vehicles 20 operated on the extracted operation routes.

Subsequent to Step S31, the server controller 12 extracts, from the plurality of facilities included in the facility information, a facility that is located in the vicinity of the operation routes of the candidates for the boarding vehicle and that has an attribute matching the purpose information, as the first facility (Step S32). The first facility extracted by the server controller 12 may be one or more in number. The server controller 12 determines a candidate for the boarding vehicle that can be used for traveling to the first facility matching the purpose information as the boarding vehicle (Step S33).

For example, in the example illustrated in FIG. 9, when the candidates for the boarding vehicle travel along operation routes R1 and R2, facilities F2 and F4 having an attribute matching the purpose information are extracted as the first facilities from the facilities located near operation routes R1 and R2. The server controller 12 may extract only a single facility from facilities F2 and F4 as the first facility, based on the priority information, the congestion information, or the like.

Subsequent to Step S33, the server controller 12 extracts the boarding location at which the user is to board and the alighting location at which the user is to alight, based on the operation route of the vehicle 20 which is the boarding vehicle (Step S34). Subsequent to Step S34, the processing by the server controller 12 returns to the flowchart of FIG. 8.

Upon extracting the first facility in Step S12, the server controller 12 transmits, to the information terminal 30, the proposal information including facility identification information for the first facility as illustrated in FIG. 7 (Step S13). The facility identification information is information identifying the first facility. For example, the facility identification information may be an ID that is, for example, a numerical value uniquely identifying the facility. The facility identification information may further include a facility name, and the second location information indicating the location of the facility. The proposal information may include, in addition to the facility identification information, the attribute information for the facility, and the boarding location and the boarding time and the alighting location and the alighting time for the boarding vehicle. When the plurality of first facilities are extracted, the server controller 12 may transmit a plurality of pieces of proposal information to the information terminal 30. The server controller 12 may transmit more detailed information regarding the first facility to the information terminal 30. For example, the server controller 12 may transmit, to the information terminal 30, the more detailed information regarding the first facility, and an URL address or the like of a web page to the first facility. After transmitting the proposal information to the information terminal 30, the server controller 12 waits for a response from the information terminal 30.

Upon receiving the proposal information from the server 10, the information terminal 30 displays information according to the received proposal information on the input/output interface that is, for example, the touch panel. For example, the information terminal 30 displays the name and the location of the first facility, based on the facility identification information. For example, the information terminal 30 displays the boarding location and the boarding time to board the boarding vehicle, and the alighting location and the alighting time to alight from the boarding vehicle. The information on the boarding location and the alighting location may be displayed on the map. When receiving the plurality of pieces of proposal information from the server 10, the information terminal 30 may display the information in a list format.

The information terminal 30 may display more detailed information based on the proposal information. Suppose, for example, that the attribute information is hierarchical as illustrated in FIG. 4 and that the information terminal 30 receives the attribute information up to the third level. When the information terminal 30 transmits “dining” as the purpose information included in the request information, the information terminal 30 may display the type of dining, such as Japanese, Western, or Chinese, provided by the restaurant that has been extracted based on the received attribute information.

The user considers the information displayed on the information terminal 30 and, when deciding to travel to the first facility, transmits from the information terminal 30 the first response indicating acceptance of the proposal information. When deciding not to travel to the first facility, the user transmits, from the information terminal 30 to the server 10, the second response indicating non-acceptance of the proposal information.

Subsequent to Step 13, the server controller 12 waits to receive the first response and the second response from the information terminal 30. When the information terminal 30 transmits the first response or the second response to the server 10, the server controller 12 receives the response via the server communication interface 14 (Step S14). When the received response is the first response indicating acceptance of the proposal information (Step S15: Yes), the server controller 12 moves to Step S18. When the received response is the second response indicating non-acceptance of the proposal information (Step S15: No), the server controller 12 moves to Step S16.

When the server communication interface 14 receives the second response, the server controller 12 extracts, from the plurality of facilities included in the facility information, a second facility that is different from the first facility and that matches the purpose information (Step S16). The server controller 12 updates each of the boarding vehicle, the boarding location, the boarding time, the alighting location, and the alighting time, in accordance with the second facility.

For example, suppose that, in the example of FIG. 9, there are facilities F2 and F4 which match the purpose information and for which the boarding vehicle that can be used for travelling has been extracted and that the server controller 12 has extracted facility F2 as the first facility in Step S23. In this case, the server controller 12 may extract facility F4 as the second facility in Step S16.

The server controller 12 transmits, to the information terminal 30, the proposal information including the facility identification information regarding the second facility via the server communication interface 14 (Step S17). After transmitting the proposal information including the facility identification information regarding the second facility to the information terminal 30, the server controller 12 waits to receive the first response or the second response from the information terminal 30. Upon receiving the proposal information including the facility identification information regarding the second facility, the information terminal 30 presents this information to the user, in a manner similar to when receiving the proposal information including the facility identification information regarding the first facility. The user operates the information terminal 30 to transmit, to the server 10, the first response indicating acceptance of the proposal information or the second response indicating non-acceptance of the proposal information (Step S14).

After that, when the user does not accept the proposal transmitted from the server 10, Steps S14 through S17 are repeated. The server controller 12 may terminate the processing of Steps S14 through S17 in accordance with various conditions. For example, when the information terminal 30 receives a response indicating that the user has decided to stop searching the facility information in Step S14, the server controller 12 may terminate the processing. For example, when the second facility having an attribute matching the purpose information cannot be extracted from the facility information in Step S16, the server controller 12 may notify the information terminal 30 of this via the server communication interface 14 and terminate the processing.

When the first response indicating acceptance of the proposal information has been received in Step S15, the server controller 12 establishes the user's reservation for the vehicle 20 which is the boarding vehicle. Upon establishing the reservation, the server controller 12 transmits the boarding information to the vehicle 20 which is the boarding vehicle that the user is to board (Step S18). The boarding information includes the boarding permission information, and the information indicating the boarding location and the alighting location. The boarding information may further include times, such as the boarding time and the alighting time. The boarding permission information is the information that the control apparatus 22 of the vehicle 20 can use to verify the user when the user boards the vehicle 20 which is the boarding vehicle. For example, the boarding permission information may be the user identification information. Alternatively, the boarding permission information may be different information, such as numerical information associated with the user identification information in the server controller 12. For example, after receiving the first response, the server controller 12 may generate the numerical information as the boarding permission information and transmit the generated information to both the vehicle 20 and the information terminal 30.

When the first response has been received and when the reservation has been established in Step S18, the server controller 12 may provide an incentive to the user. The incentive may be provided, for example, by returning a fare for the vehicle 20 to the user. The incentive may be provided, for example, as points that can be used for payment of the fare for the vehicle 20. The incentive may be provided as electronic money. The incentive may be provided as points that can be exchanged for a product or a service. A record of the incentive provided may be stored as the incentive information in association with the user identification information, and may be managed by the server controller 12. The incentive information may be stored, for example, in a memory such as the DB15. The user may access his or her own incentive information from the information terminal 30 and check and use the provided incentive.

The server controller 12 may change the level of the incentive that is to be provided to the user depending on various conditions. For example, the server controller 12 may change the incentive to be provided depending on the facility the user has selected. For example, the server controller 12 may be configured, when the first response has been received without receipt of the second response, to provide a higher incentive to the user than when the first response has been received after receipt of the second response. This allows the server controller 12 to induce the user toward a facility with a high priority.

The time at which the server controller 12 provides the incentive does not need to coincide with the time when the reservation is established after the receipt of the first response. For example, the server controller 12 may provide the incentive when the user boards the vehicle 20 which is the boarding vehicle, or when the user alights form the vehicle 20.

(Operation of Boarding Vehicle)

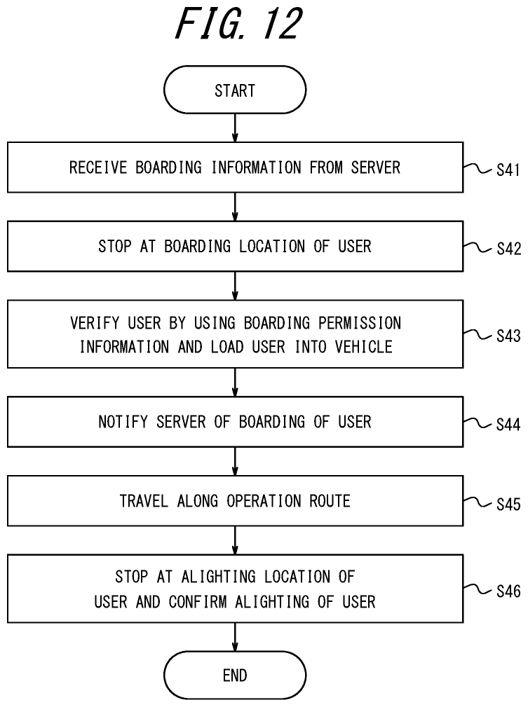

Hereinafter, with reference to FIG. 12, processing that the control apparatus 22 of the vehicle 20 which is the boarding vehicle executes upon receiving the boarding information from the server 10 will be described.

The control apparatus 22 of the vehicle 20 which is the boarding vehicle receives, via the communication apparatus 24, the boarding information, which includes the boarding permission information and the information indicating the boarding location and the alighting location, that the server controller 12 has transmitted in Step S18 of FIG. 8 (Step S41). The control apparatus 22 may further receive information indicating the boarding time and the alighting time.

The vehicle 20 which is the boarding vehicle stops at the boarding location on the operation route based on the information received from the server 10 that indicates the user's boarding location (Step S42).

When the user approaches, the vehicle 20 which is the boarding vehicle verifies that the user is the user who has made the reservation by referring to the boarding permission information, and loads the user into the vehicle 20 (Step S43). For example, the control apparatus 22 of the vehicle 20 acquires the boarding permission information from the information terminal 30 via the communication apparatus 24. When the boarding permission information acquired from the information terminal 30 matches the boarding permission information received from the server 10, the control apparatus 22 may verify that the user in possession of the information terminal 30 is the user who has made the reservation. The communication apparatus 24 of the vehicle 20 and the information terminal 30 can communicate by using the network 40 or other communication means. The other communication means may include, for example, Bluetooth® (Bluetooth is a registered trademark in Japan, other countries, or both) and near field communications. As an alternative method, the information terminal 30 may display, on the input/output interface, the boarding permission information that is coded. The vehicle 20 may read the information by using an optical reader.

Upon loading the user, the vehicle 20 which is the boarding vehicle notifies the server 10 that the user has boarded (Step S44). If the vehicle 20 which is the boarding vehicle arrives at the boarding location and the user has not boarded the vehicle 20 after a predetermined time from the scheduled boarding time has elapsed, the control apparatus 22 may inform the server 10 of this via the communication apparatus 24. The server controller 12 may store in the memory that the user has boarded or has not boarded. If the user has not boarded the vehicle 20 which is the boarding vehicle, the server controller 12 may notify the information terminal 30 of this.

Subsequent to Step S44, the vehicle 20 which is the boarding vehicle travels along the operation route (Step S45).

When arriving at the alighting location of the user, the vehicle 20 which is the boarding vehicle stops to let the user alight (Step S46). When the user has alighted, the control apparatus 22 of the vehicle 20 may notify the server 10 of the alighting of the user via the communication apparatus 24.

As has been described, according to the vehicle operation system 1 of the present embodiment, because the server 10 proposes the facility matching the purpose information of the user, together with the vehicle 20 that the user can board, the flexibility in travel for the user according to the purpose is improved. Because the server 10 is capable of searching the operation schedule information for the vehicle 20, immediate proposal of the vehicle 20 in the plurality of vehicles 20 that the user can board is possible. Further, because the server 10 is capable of acquiring the congestion information on the operation route, extraction of the appropriate facility and extraction of the appropriate boarding and alighting locations depending on the congestion information is possible.

Further, according to the vehicle operation system 1 of the present embodiment, when the number of people who are scheduled to board the vehicle 20 for which the operation schedule has been determined is less than the maximum capacity, the user can board the vehicle 20, whereby the usage efficiency of the vehicle 20 is improved.

Additionally, the present disclosure is not limited to the above embodiment, and various modifications and revisions may be implemented. For example, functions or the like included in each means, each step, or the like can be rearranged without logical inconsistency, and a plurality of means, steps, or the like can be combined together or divided.

1. A server comprising:
a communication interface configured to receive, from an information terminal, request information including first location information and purpose information, the first location information indicating a location of a user, and the purpose information indicating a travel purpose of the user; and
a controller configured to search operation schedule information indicating respective operation routes of a plurality of vehicles and times at which each vehicle is scheduled to pass through a plurality of places on a corresponding operation route, and facility information including second location information and attribute information, the second location information indicating respective locations of a plurality of facilities, and the attribute information indicating respective attributes of the plurality of facilities, the controller being configured to, when the communication interface has received the request information, extract a first facility in the plurality of facilities that has an attribute matching the purpose information, a boarding vehicle in the plurality of vehicles that can be used by the user to travel to the first facility, and a boarding location on an operation route of the boarding vehicle at which the user is to board and an alighting location on the operation route of the boarding vehicle at which the user is to alight, based on the operation schedule information, the facility information, and the request information.

2. The server according to claim 1, wherein
the controller is configured to perform extraction of the first facility by:
selecting at least one candidate for the first facility that has an attribute matching the purpose information from the plurality of facilities included in the facility information, and
extracting the first facility from the at least one candidate for the first facility based on the second location information regarding the at least one candidate for the first facility, the first location information, and the operation schedule information.

3. The server according to claim 1, wherein
the controller is configured to perform extraction of the first facility by:
selecting at least one candidate for the boarding vehicle based on the first location information and the operation schedule information, and
extracting from the plurality of facilities the first facility that is located in the vicinity of an operation route of the at least one candidate for the boarding vehicle and that has an attribute matching the purpose information based on the facility information and the operation schedule information regarding the at least one candidate for the boarding vehicle.

4. The server according to claim 1, wherein
the controller is configured to update the operation schedule information based on congestion information indicating a congestion condition on each operation route.

5. The server according to claim 4, wherein
the controller is configured to receive the congestion information from the plurality of vehicles via the communication interface.

6. The server according to claim 4, wherein
the controller is configured to determine the boarding location and the alighting location on the operation route of the boarding vehicle based on the congestion information.

7. The server according to claim 1, wherein
the attribute information is selected from a plurality of attributes including a shop and a leisure facility.

8. The server according to claim 1, wherein
the attribute information is hierarchical in two or more levels.

9. The server according to claim 1, wherein
the facility information includes information about a priority of each facility in the plurality of facilities, and when extracting the first facility, the controller preferentially extracts a facility the priority of which is high from the plurality of facilities.

10. The server according to claim 1, wherein
the facility information further includes facility identification information identifying each facility in the plurality of facilities, and after the communication interface has received the request information, the controller transmits proposal information including the facility identification information regarding the first facility to the information terminal via the communication interface and waits to receive a first response or a second response from the information terminal, the first response indicating acceptance of the proposal information, and the second response indicating non-acceptance of the proposal information.

11. The server according to claim 10, wherein
the controller is configured to include information indicating the boarding location and the alighting location in the proposal information.

12. The server according to claim 10, wherein
when the communication interface has received the second response, the controller extracts a second facility different from the first facility from the plurality of facilities, updates each of the boarding vehicle, the boarding location, and the alighting location in accordance with the second facility, transmits proposal information including the facility identification information regarding the second facility to the information terminal via the communication interface, and waits to receive a first response or a second response from the information terminal.

13. The server according to claim 10, wherein
the request information further includes user identification information identifying the user, and when the communication interface has received the first response, the controller transmits, to the boarding vehicle, boarding permission information associated with the user identification information, and information indicating the boarding location and the alighting location.

14. The server according to claim 13, further comprising
a memory, wherein,
when the communication interface has received the first response, the controller stores, in the memory, information about an incentive to be provided to the user in association with the user identification information.

15. The server according to claim 14, wherein
when the first response has been received without receipt of the second response, the controller provides a higher incentive to the user than when the first response has been received after receipt of the second response.

16. A vehicle operation system comprising:
the server according to claim 1; and
a plurality of vehicles each configured to be operated in accordance with the operation schedule information.

17. A vehicle operation method comprising:
receiving, from an information terminal, request information including first location information and purpose information, the first location information indicating a location of a user, and the purpose information indicating a travel purpose of the user; and
extracting, based on the request information, operation schedule information indicating respective operation routes of a plurality of vehicles and times at which each vehicle is scheduled to pass through a plurality of places on a corresponding operation route, and facility information including second location information indicating respective locations of a plurality of facilities and attribute information indicating respective attributes of the plurality of facilities, a first facility in the plurality of facilities that has an attribute matching the purpose information, a boarding vehicle in the plurality of vehicles that can be used by the user to travel to the first facility, and a boarding location on an operation route of the boarding vehicle at which the user is to board and an alighting location on the operation route of the boarding vehicle at which the user is to alight.

18. The vehicle operation method according to claim 17, comprising
updating the operation schedule information based on congestion information indicating a congestion condition on each operation route.

19. A non-transitory computer readable medium storing a vehicle operation program configured to cause a processor to execute operations comprising:
acquiring request information including first location information and purpose information, the first location information indicating a location of a user, and the purpose information indicating a travel purpose of the user; and
extracting, based on the request information, operation schedule information indicating respective operation routes of a plurality of vehicles and times at which each vehicle is scheduled to pass through a plurality of places on a corresponding operation route, and facility information including second location information indicating respective locations of a plurality of facilities and attribute information indicating respective attributes of the plurality of facilities, a first facility in the plurality of facilities that has an attribute matching the purpose information, a boarding vehicle in the plurality of vehicles that can be used by the user to travel to the first facility, and a boarding location on an operation route of the boarding vehicle at which the user is to board and an alighting location on the operation route of the boarding vehicle at which the user is to alight.

20. The non-transitory computer readable medium according to claim 19, the operations comprising
updating the operation schedule information based on congestion information indicating a congestion condition on each operation route.
